(19) United States
(12) Patent Application Publication
(10) Pub. No.: US 2005/0205825 A1
(43) Pub. Date: Sep. 22, 2005

(54) Housing flange unit

(75) Inventors: Rolf Anschicks, Butzbach (DE); Lothar Schroeder, Karben (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/111,952

(22) Filed: Apr. 22, 2005

Related U.S. Application Data
(63) Continuation of application No. PCT/DE03/03289, filed on Oct. 2, 2003.

(30) Foreign Application Priority Data
Nov. 26, 2002 (DE) 10255103.0

(51) Int. Cl. F16K 1/22

(52) U.S. Cl. 251/305

(57) ABSTRACT

The present invention relates to a housing flange unit including a housing flange, within which a throttle shaft that is provided with a centrally located throttle is rotatably mounted perpendicular to the longitudinal axis of the housing flange inside a first bearing and a second bearing. The inventive housing flange unit also includes a housing flange made of red brass and a wall thickness of 2 to 4 mm. The invention also relates to the use of the housing flange unit as a sealing unit for an exhaust gas cooler.

### CROSS REFERENCE RO RELATED APPLICATIONS

The present application is a continuation of International Application Serial Number PCT/DE2003/003289, filed Oct. 2, 2003, which designated the United States and further claims priority to German patent application 102 55 103.0, filed Nov. 26, 2002, the both of which are herein incorporated by reference.

The invention relates to a housing flange unit which comprises a housing flange, in which, perpendicular to the longitudinal axis of the housing flange, a throttle shaft having a centrally arranged throttle is mounted rotatably in a first bearing and a second bearing. The invention furthermore relates to the use of the housing flange unit.

Housing flange units are known. They generally have gases flowing through them and are of multipart construction. The throttle arranged on the throttle shaft is used for closing pipeline units. It is generally desirable in this case for it not to be possible for the gases to pass into the open air via the bearings of the throttle shaft, particularly if the gases contain harmful substances. This possibility is created by the throttle shaft generally being driven from the outside and by it not being possible to effectively realize appropriate sealing by means of sealing rings as a consequence of high temperatures to which the housing flange unit is generally exposed. For operating temperatures of above 450° C., the housing flange of a housing flange unit of this type is generally produced from gray cast iron, with wall thicknesses in the range of from 4.5 to 5.5 mm being provided. In this case, it is disadvantageous that the housing flange unit is relatively heavy.

The invention is therefore based on the object of providing a housing flange unit which is relatively light and at the same time has high corrosion resistance.

The object on which the invention is based is achieved by the housing flange unit consisting of red brass and having a wall thickness g of from 2 to 4 mm. In this case, the designation red brass is to be understood as meaning a copper-tin alloy (bronze) in which some of the tin is generally replaced by 1 to 6% of zinc. It has surprisingly been shown that this enables the weight of the housing flange unit to be reduced by virtually 35%, with high corrosion resistance, in particular with regard to sulfureous acid or sulfuric acid, being ensured at the same time.

One preferred refinement of the invention resides in the wall thickness g being between 2 and 3 mm. In this case, a wall thickness g of 2.5 mm is preferred. This enables a further weight saving to be realized in a simple manner.

According to a further preferred refinement of the invention, provision is made for the housing flange to consist of CuSn5Zn5Pb5-C. This material is designated in accordance with DIN EN 1982 and is also listed under the material No. 2,1096. A widely used abbreviation of this material is Rg5. It is advantageous in this case that the throttle shaft can be mounted rotatably relatively easily in the first bearing and in the second bearing, since the arrangement of additional bearing parts, such as, for example, bearing bushings or sleeves, can be dispensed with.

According to a further refinement of the invention, provision is made for the housing flange to have differing percentage by mass areas of Sn in the range of from 2 to 8%, of Zn in the range of from 1 to 10% and of Pb in the range of from 1 to 5%. These materials are suitable in a particularly advantageous manner as the material for the housing flange, with the housing flange unit having relatively high corrosion resistance for many application purposes.

According to a further preferred refinement of the invention, the throttle shaft is mounted rotatably in the first bearing and in the second bearing without an additional seal. The arrangement of additional seals can be dispensed with, since, owing to the lower coefficient of thermal expansion, a wedging of the throttle shaft in the housing flange can be avoided even during fluctuating temperatures of the gases to be conducted through the housing flange unit. In this case, a disadvantageous escape of gases into the open air via the bearings of the throttle shaft is additionally effectively avoided.

According to a further refinement of the invention, provision is made for the throttle shaft to have a gap of from 0.018 to 0.025 mm from the first bearing and from the second bearing. A gap of 0.020 mm has proven particularly suitable at temperatures above 700° C. The gap is understood here as meaning the distance between the throttle shaft and the inner wall of the first bearing or of the second bearing (tolerance). As a result, a relatively high sealing effect for gases is obtained.

Finally, the invention also relates to the use of the housing flange unit as a sealing unit for an exhaust gas cooler of a motor vehicle. It is precisely in the case of a motor vehicle's exhaust gases that it is desirable that the exhaust gases do not pass into the open air through the mounting of the throttle shaft. Furthermore, it is desirable to keep some of the exhaust gases at a higher temperature. The division of the exhaust gas stream can be simply realized in a particularly advantageous manner by the housing flange unit, with an escape from the housing flange unit being avoided, in which case the arrangement of additional seals can be dispensed with.

The invention is explained in more detail below by way of example with reference to the drawing (fig.).

The FIGURE shows the housing flange unit in cross section together with the actuator.

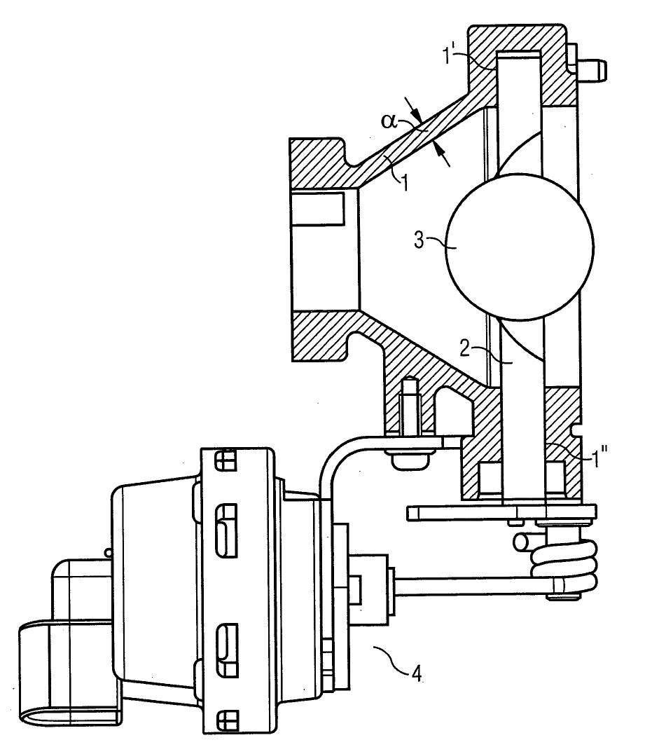

FIG. 1 illustrates the housing flange unit together with the actuator 4 in cross section in simplified form and schematically. The housing flange unit comprises a housing flange 1 in which, perpendicular to the longitudinal axis of the housing flange 1, a throttle shaft 2 having a centrally arranged throttle 3 is mounted rotatably in a first bearing 1′ and a second bearing 1″. The housing flange 1 consists of red brass and has a wall thickness g of 2 to 4 mm. That end of the throttle shaft 2 which is positioned on the second bearing 1″ is connected to the actuator 4. The actuator 4 can cause the throttle shaft 2 to rotate and the throttle 3 to be correspondingly changed in its position. An arrangement of additional seals in the first bearing 1′ or in the second bearing 1″ is advantageously not provided. The housing flange unit illustrated is suitable in particular as a sealing unit for an exhaust gas cooler of a motor vehicle.

1. A housing flange unit, comprising:
a housing flange in which, perpendicular to a longitudinal axis of the housing flange, a throttle shaft having a centrally arranged throttle is mounted rotatably in a first bearing and a second bearing, wherein the housing flange comprise red brass and has a wall thickness of 2 to 4 mm.

2. The housing flange unit according to claim 1, wherein the wall thickness is between 2 and 3 mm.

3. The housing flange unit according to claim 1, wherein the housing flange comprises CuSn5Zn5Pb5-C.

4. The housing flange unit according to claim 3, wherein the housing flange has differing percentage by mass areas of Sn in the range of 2 to 8%, of Zn in the range of from 1 to 10% and of Pb in the range of firm 1 to 5%.

5. The housing flange unit according to claims 1, wherein the throttle shaft is mounted rotatably in the first bearing and in the second bearing without an additional seal.

6. The housing flange unit according to claim 5, wherein the throttle shaft has a gap of from 0.018 to 0.025 mm from the first bearing and from the second bearing.

7. (canceled)

8. The housing flange unit according to claim 2, wherein the housing flange comprises CuSn5Zn5Pb5-C.

9. The housing flange unit according to claim 2, wherein the throttle shaft is mounted rotatably in the first bearing and in the second bearing without an additional seal.

10. The housing flange unit according to claim 3, wherein the throttle shaft is mounted rotatably in the fist bearing and in the second bearing without an additional seal.

11. The housing flange unit according to claim 4, wherein the throttle shaft is mounted rotatably in the first bearing and in the second bearing without an additional seal.
